(19) United States
(12) Patent Application Publication
(10) Pub. No.: US 2025/0368490 A1
(43) Pub. Date: Dec. 4, 2025

(54) ADJUSTABLE SADDLE ASSEMBLY FOR A VEHICLE JACK

(71) Applicant: Harbor Freight Tools USA, Inc., Calabasas, CA (US)

(72) Inventor: Andrew McGraw, Newbury Park, CA (US)

(21) Appl. No.: 18/732,338

(22) Filed: Jun. 3, 2024

(51) Int. Cl. B66F 13/00; B66F 5/02

(52) U.S. Cl. CPC B66F 13/00; B66F 5/02

(57) ABSTRACT

An adjustable saddle assembly for a vehicle jack is disclosed. The saddle assembly comprises a saddle body including a saddle face, a vehicle interface adapter, and a releasable adapter engagement mechanism. The releasable adapter engagement mechanism is operable to secure the vehicle interface adapter in a stowed configuration and a deployed configuration. When in the stowed configuration, the vehicle interface adapter is substantially positioned within an adapter cavity disposed in the saddle body.

### BACKGROUND

The present disclosure relates generally to an adjustable saddle assembly for a vehicle jack including an integrated vehicle interface adapter.

Traditional vehicle jacks include a shallow cup saddle positioned on a mounting bracket of a lifting arm to contact a suitable lifting point on a vehicle. These traditional saddles typically include a circumferential saddle ridge defining a recess. Disposed within the recess is a saddle face. Such a traditional saddle has an approximately 10:1 diameter to depth ratio. These traditional saddles sometimes included a rubber or polyurethane pad disposed within the recess to assist providing a secure lifting contact with a vehicle. Additionally, traditional saddles may include a plurality of shallow landings to help engage an edge of a vehicle interface point. These traditional saddles are suitable to provide a secure lifting contact for flat lifting points found on body-on-frame rails and round axle tubes.

Modern unibody or uniframe vehicles often do not have flat lifting points or round axle tubes suitable for use with a traditional jack saddle. Rather, such modern unibody/uniframe vehicles typically include factory specified reinforced lifting and/or support points. While some of these lifting points (e.g., raised boxed boss or a reinforced section of subframe or crossmember) may be compatible with traditional saddles, many are not.

For example, some vehicles with reinforced pinch seams or other rib-shaped lift points are not able to effectively interface with a traditional saddle. Such vehicles require a saddle including a channel to properly distribute the lifting forces into the body of the vehicle's sheet metal. Other vehicles have reinforced hole lifting points. Such vehicles require a saddle including a centering pin. While channel and pin adapters exist, such adapters may not be suitable for a specific jack (e.g., the adapter may not fit on the saddle face within the circumferential saddle ridge) and may result in an unstable interface between the vehicle and the jack. Additionally, because such adapters are a separate component from the vehicle jack, an operator may misplace the adapter.

It is therefore advantageous to provide a securely mounted, onboard stowed, vehicle interface adapter for effective and safe lifting of a vehicle that has specific factory lift/support points which are not suitable for a traditional shallow cup shaped jack saddle. Because such a vehicle interface adapter is integrally attached to the saddle assembly, the adapter is more stable, safer, and capable of passing third party standards for offset loading.

### SUMMARY

An adjustable saddle assembly for a vehicle jack is disclosed, as illustrated by and described in connection with the figures of the present disclosure, and as set forth in the claims.

Specifically, disclosed is an example saddle assembly for a vehicle jack. The saddle assembly includes a saddle body that includes a saddle face. The saddle assembly further includes a vehicle interface adapter and a releasable adapter engagement mechanism. The releasable adapter engagement mechanism is operable to secure the vehicle interface adapter in a stowed configuration and a deployed configuration.

In one example, the saddle body includes an adapter cavity and the stowed configuration includes substantially positioning the vehicle interface adapter within the adapter cavity. In another example, when the vehicle interface adapter is in the stowed configuration, the vehicle interface adapter is substantially co-planar with the saddle face. In another example, the deployed configuration includes positioning the vehicle interface adapter on the saddle face, such that the vehicle interface adapter is operable to engage a lift point of a vehicle.

In an additional example, the vehicle interface adapter includes a channel operable to engage the lift point of the vehicle, wherein the lift point of the vehicle is a pinch seam. In one example, the saddle body further includes a circumferential saddle ridge and a plurality of notches disposed on the circumferential saddle ridge. In this example, at least one of the plurality of notches corresponds with the channel when the vehicle interface adapter is in the deployed configuration. In another example, the vehicle interface adapter includes a pin operable to engage a corresponding recess on the vehicle.

In another example, the releasable adapter engagement mechanism includes at least one fastener and at least one corresponding bore disposed on the saddle face, and the vehicle interface adapter includes at least one adapter bore. In this example, the at least one fastener is operable to engage with at least one interface bore and the at least one corresponding bore to secure the vehicle interface adapter to the saddle body in the stowed configuration and the deployed configuration. In another example, the releasable adapter engagement mechanism further includes a tool operable to engage the at least one fastener. In yet another example, the saddle body further includes a tool storage recess operable to stow the tool within the saddle body.

In one example, the vehicle interface adapter includes at least one alignment protrusion and the saddle face includes at least one stowed configuration alignment recess and at least one deployed configuration alignment recess. In this example, a positioning of the at least one alignment protrusion relative to the at least one stowed configuration alignment recess is asymmetrical, thereby ensuring that the vehicle interface adapter is properly positioned in the stowed configuration; and a positioning of the at least one alignment protrusion relative to the at least one deployed configuration alignment recess is asymmetrical, thereby ensuring that the vehicle interface adapter is properly positioned in the deployed configuration.

In another example, the releasable adapter engagement mechanism includes a pivot rod disposed in the adapter cavity and positioned at least partially within a pivot bore of the vehicle interface adapter. The releasable adapter engagement mechanism also includes a spring positioned around the pivot rod and an alignment recess disposed on the saddle face. In this example, the alignment recess is angularly offset from the adapter cavity and defines a shape that substantially conforms to the vehicle interface adapter. Also in this example, the vehicle interface adapter is operable to pivot about the pivot rod into the deployed configuration. Also in this example, the vehicle interface adapter is substantially positioned within the alignment recess when in the deployed configuration and the spring biases the vehicle interface adapter toward the adapter cavity, such that when the vehicle interface adapter is aligned with either of the adapter cavity or the alignment recess, it is positively seated.

Also disclosed is an example vehicle jack. The vehicle jack includes a body and lifting arm pivotally connected to the body operable to move between an upper extended position and a lower retracted position. The vehicle jack further includes a mounting bracket pivotally connected to an end of the lifting arm and a jack saddle assembly fastened to the mounting bracket. The jack saddle assembly includes a saddle body that includes a saddle face. The jack saddle assembly further includes a vehicle interface adapter and a releasable adapter engagement mechanism. The releasable adapter engagement mechanism is operable to secure the vehicle interface adapter in a stowed configuration and a deployed configuration.

In one example, the saddle body includes an adapter cavity and the stowed configuration includes substantially positioning the vehicle interface adapter within the adapter cavity. In another example, when the vehicle interface adapter is in the stowed configuration, the vehicle interface adapter is substantially co-planar with the saddle face. In another example, the deployed configuration includes positioning the vehicle interface adapter on the saddle face, such that the vehicle interface adapter is operable to engage a vehicle.

In one example, the vehicle interface adapter includes a channel operable to engage a rib-shaped lift point on the vehicle. In another example, the saddle body further includes a circumferential saddle ridge and a plurality of notches disposed on the circumferential saddle ridge. In this example, at least one of the plurality of notches is positioned in-line with the channel when the vehicle interface adapter is in the deployed configuration. In another example, the vehicle interface adapter includes a pin operable to engage a corresponding recess on the vehicle.

In another example, the releasable adapter engagement mechanism includes at least one threaded fastener and at least one corresponding threaded bore disposed on the saddle face, and the vehicle interface adapter includes at least one adapter bore. In this example, the at least one threaded fastener is operable to engage with at least one interface bore and the at least one corresponding threaded bore to secure the vehicle interface adapter to the saddle body in the stowed configuration and the deployed configuration. In one example, the releasable adapter engagement mechanism further includes a tool operable to engage the at least one threaded fastener, and the at least one threaded fastener includes a countersunk allen bolt. In another example, the saddle body further includes a tool storage recess operable to stow the tool within the saddle body.

In another example, the vehicle interface adapter includes at least one alignment protrusion and the saddle face includes at least one stowed configuration alignment recess and at least one deployed configuration alignment recess. In this example, a positioning of the at least one alignment protrusion relative to the at least one stowed configuration alignment recess is unidirectional, thereby ensuring that the vehicle interface adapter is properly positioned in the stowed configuration; and a positioning of the at least one alignment protrusion relative to the at least one deployed configuration alignment recess is unidirectional, thereby ensuring that the vehicle interface adapter is properly positioned in the deployed configuration.

In one example, the releasable adapter engagement mechanism includes a pivot rod disposed in the adapter cavity and positioned at least partially within a pivot bore of the vehicle interface adapter. The releasable adapter engagement mechanism further includes a spring positioned around the pivot rod and an alignment recess disposed on the saddle face. In this example, the alignment recess is substantially perpendicular to the adapter cavity and defines a shape that substantially conforms to the vehicle interface adapter. Also in this example, the vehicle interface adapter is operable to pivot about the pivot rod into the deployed configuration. Also in this example, the vehicle interface adapter is substantially positioned within the alignment recess when in the deployed configuration and the spring biases the vehicle interface adapter toward the adapter cavity, such that when the vehicle interface adapter is aligned with either of the adapter cavity or the alignment recess, it is positively seated.

Also disclosed is an example method of configuring a vehicle interface adapter for a vehicle jack from a stowed configuration into a deployed configuration. The method includes providing a vehicle jack with a saddle assembly, the saddle assembly including a saddle body, a saddle face, an adapter cavity, an alignment recess, and a releasable adapter engagement mechanism. The method further includes removing the vehicle interface adapter from the stowed configuration. The method further includes positioning the vehicle interface adapter within the alignment recess into the deployed configuration.

In one example, the releasable adapter engagement mechanism includes at least one threaded fastener and at least one corresponding threaded bore disposed within the alignment recess, and the vehicle interface adapter includes at least one adapter bore. In this example, the method further includes releasing the vehicle interface adapter from the stowed configuration by dis-engaging and removing the least one threaded fastener from the at least one corresponding threaded bore and adapter bore. Also in this example, the method further includes securing the vehicle interface adapter into the deployed configuration by inserting the at least one threaded fastener through the adapter bore and re-engaging the at least one threaded fastener with the at least one corresponding threaded bore.

In another example, the releasable adapter engagement mechanism includes a pivot rod, disposed in the adapter cavity and positioned at least partially within a pivot bore of the vehicle interface adapter. In this example, the releasable adapter engagement mechanism further includes a spring positioned around the pivot rod, which biases the vehicle interface adapter toward the adapter cavity, such that when the vehicle interface adapter is aligned with either of the adapter cavity or the alignment recess, it is positively seated. In this example, the method further includes raising the vehicle interface adapter above the saddle face and rotating the vehicle interface adapter about the pivoting rod.

### BRIEF DESCRIPTION OF SEVERAL VIEWS OF THE DRAWINGS

The following is a brief description of the drawings pertaining to the present disclosure, which will be discussed in more detail in the detailed description section below:

FIG. 1 illustrates a perspective view of a vehicle jack including an adjustable saddle assembly.

FIG. 2 illustrates a partial cut-away view of the vehicle jack of FIG. 1, depicting the lifting arm in a raised configuration and exemplary internal components of the vehicle jack.

FIG. 3 illustrates an exploded perspective view of one embodiment of an adjustable saddle assembly.

FIG. 4 illustrates an assembled perspective view of the adjustable saddle assembly, showing a vehicle interface adapter in a stowed configuration.

FIG. 5 illustrates the assembled perspective view of the adjustable saddle assembly, showing the vehicle interface adapter in the deployed configuration.

FIG. 6 illustrates a cross-sectional view of the adjustable saddle assembly taken along lines 6-6 of FIG. 4.

FIG. 7 illustrates a cross-sectional view of the adjustable saddle assembly taken along lines 7-7 of FIG. 5.

FIG. 8 illustrates a cross-sectional view of the adjustable saddle assembly taken along lines 8-8 of FIG. 5.

FIG. 9 illustrates a side elevation view of the embodiment of the adjustable saddle assembly shown in FIG. 5.

FIG. 10 illustrates a side elevation view of another embodiment of the adjustable saddle assembly.

FIG. 11 illustrates an exploded perspective view of another embodiment of an adjustable saddle assembly.

FIG. 12 illustrates an assembled perspective view of the adjustable saddle assembly shown in FIG. 11, showing the vehicle interface adapter in the stowed configuration.

FIG. 13 illustrates an assembled perspective view of the adjustable saddle assembly shown in FIG. 11, showing the vehicle interface adapter in the deployed configuration.

FIG. 14 illustrates an assembled perspective view of another embodiment of the adjustable saddle assembly, showing the vehicle interface adapter in the deployed configuration.

FIG. 15 illustrates an assembled perspective view of another embodiment of the adjustable saddle assembly, showing the vehicle interface adapter in the stowed configuration.

FIG. 16 illustrates a side elevation view of the adjustable saddle assembly shown in FIG. 15.

FIG. 17 is a flow-chart of an exemplary method of configuring a vehicle interface adapter for a vehicle jack from a stowed configuration into a deployed configuration.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein.

### DETAILED DESCRIPTION

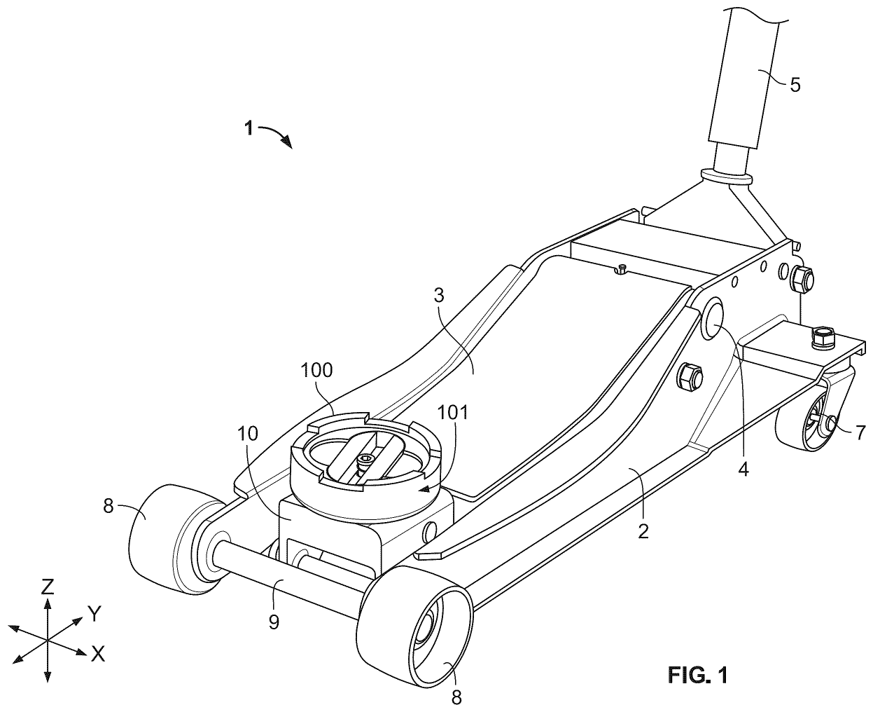

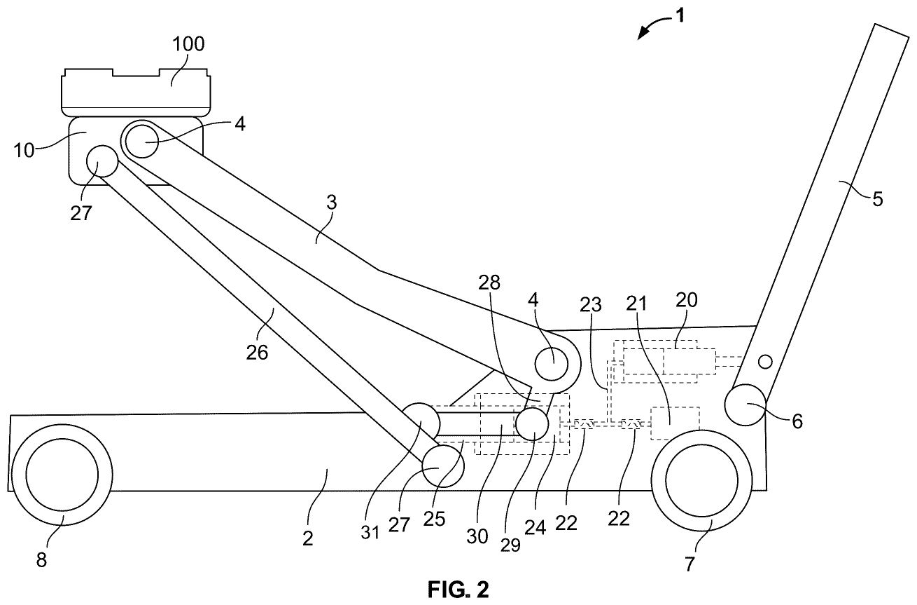

FIG. 1 shows an exemplary vehicle jack 1. Also shown in FIG. 1 are x, y, and z-axes to assist in the description of the various movements and relationships of the components of the vehicle jack 1. The vehicle jack 1 includes a body 2 and a lifting arm 3 pivotally connected to the body 2 at a lifting arm pivot 4. The vehicle jack also includes a handle 5 operable to actuate rotation of the lifting arm 3 about the X-axis at the lifting arm pivots 4, thereby selectively raising and lowering a mounting bracket 10 and a saddle assembly 100 along the z-axis between a lower retracted position (shown in FIG. 1) and an upper extended position (shown in FIG. 2). As illustrated, the saddle assembly 100 includes a saddle body 101. The saddle body 101 may include one or more attachments (i.e., a vehicle interface adapter 130) to assist an operator in lifting a wide range of vehicles (e.g., electric vehicles, non-electric vehicles, SUVs, trucks, sedans, compact cars, hatch-backs, wagons, performance vehicles, etc.). The saddle body 101 mounts to the mounting bracket 10. At the rear of the vehicle jack 1 are a pair of caster wheels 7 for turning and moving the vehicle jack 1 across surfaces. At the front of the vehicle jack 1 are a pair of front wheels 8 connected by an axle 9. The handle 5 is also operable to assist an operator in positioning and maneuvering the vehicle jack 1 on surfaces including a garage floor or driveway.

For example, FIG. 2 shows a partial cutaway view of the floor jack 1 in an upper extended position. As illustrated, the handle 5 is operable to raise the lifting arm 3 by repeatedly pumping handle 5 up and down (i.e., rotating the handle 5 about the handle pivot 6) to actuate at least one jack cylinder 20. Such pumping of the jack cylinder 20 builds up pressure of hydraulic fluid, which is transferred via a fluid conduit 23 from a low pressure reservoir 21 through one or more check valve(s) 22, into one or more fluid reservoirs 24. As pressure builds and more hydraulic fluid is transferred into the fluid reservoir 24, a ram 25 is driven outward, towards the front wheels 8. As shown, ram 25 is pivotably coupled to at least one link 30 via a first link pivot 31. Link 30 is pivotably coupled to at least one rocker arm 28 via a rocker pivot 29. Rocker arm 28 is fixed to, or integral with, the lifting arm 3. The lifting arm 3 pivotably coupled to and pivots about the lifting arm pivot 4. As the ram 25 is driven outward, ram 25 acts on (i.e., pulls) link 30, which in turn causes the rocker arm 28 and lifting arm 3 to rotate about the lifting arm pivot 4. In the illustrated embodiment, lifting arm 3 is coupled to the mounting bracket 10 via an upper lifting arm pivot 4. Lever 26, which in some embodiments may be a radius arm, is pinned between a body 2 of the floor jack 1 and the mounting bracket 10 and assists in preventing rotation of mounting bracket 10. As shown, one end of the lever 26 is connected to the body 2 of the floor jack 1 via a first lever pivot 27 and the other end of the lever 26 is connected to the mounting bracket 10 via a second lever pivot 27. As the lifting arm 3 is raised, lever 26 rotates about the lever pivots 27, providing support for any load applied to the saddle jack 100 and mounting bracket 10. The ram 25 retracts and the lifting arm 3 is lowered when pressure is released from the fluid reservoir 24.

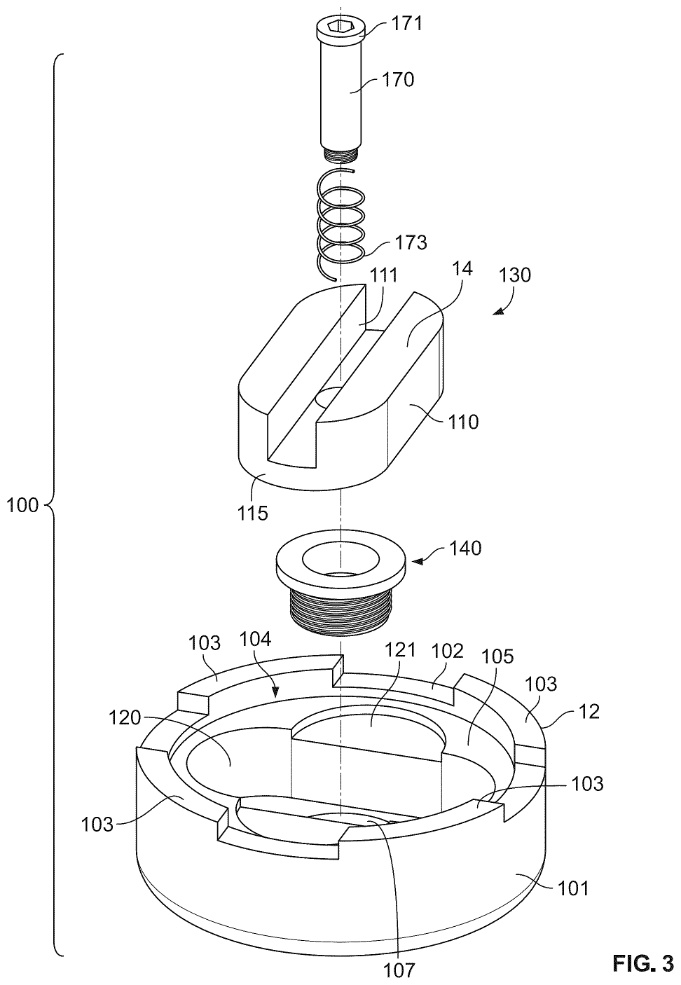

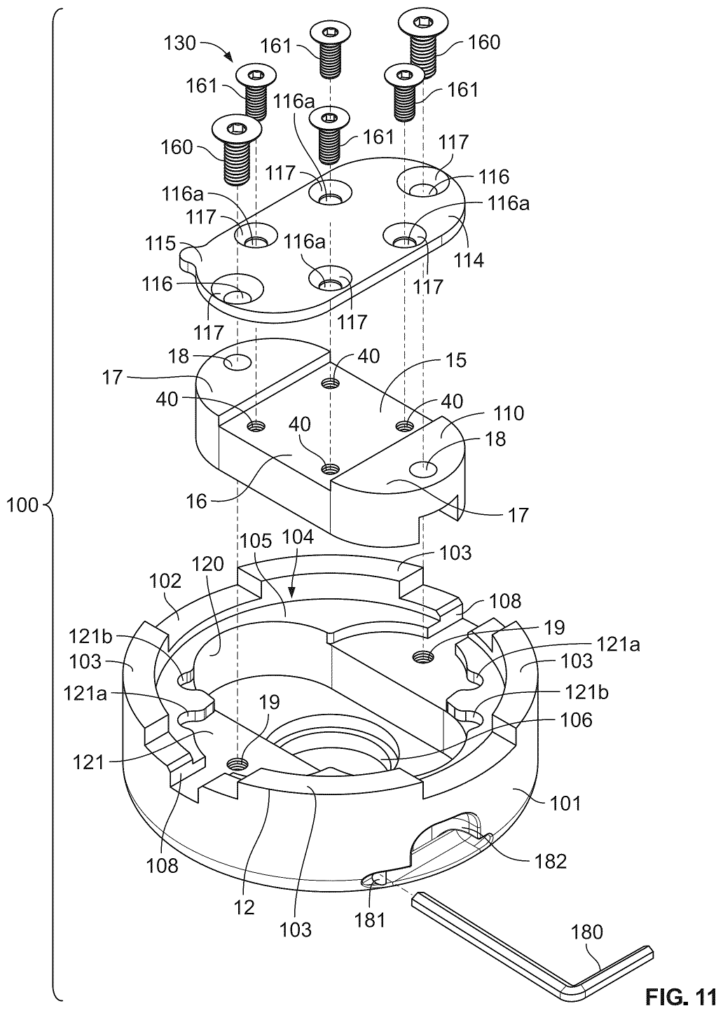

FIG. 3 shows an exploded view of one embodiment of the saddle assembly 100 for the vehicle jack 1. The saddle body 101 is made of metal (e.g., steel, high strength plastic, or aluminum) or any other suitable material for withstanding the load of a vehicle. The saddle body 101 mounts to the mounting bracket 10 using either a threaded saddle fastener 140 or a cross pin fastener 150 (shown for example in FIG. 11). The saddle body 101 has a perimeter 12 including a plurality of circumferential saddle ridges 102 and a plurality of landings 103. The perimeter 12 defines a recess 104 and surrounds the saddle face 105. It is understood that the present disclosure contemplates other plurality of landings 103, for example, a set of two, three, or six landings 103. The recess 104 operable to receive the saddle pad (not shown).

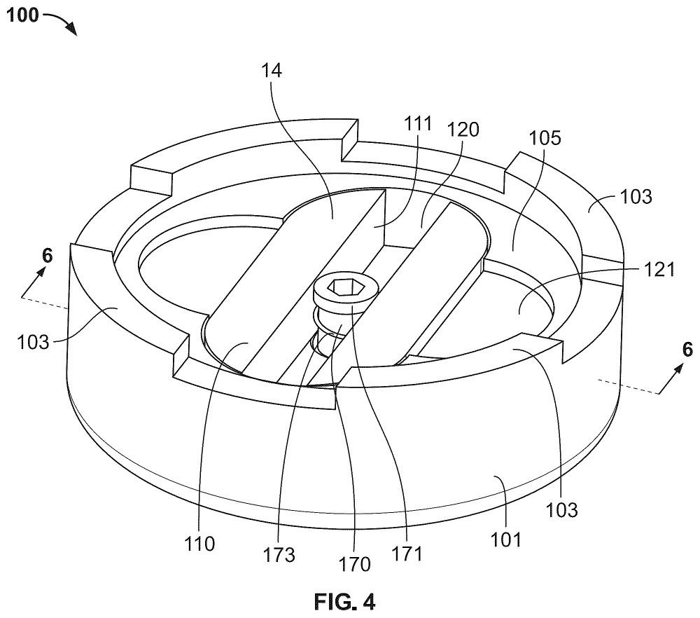

As shown in FIG. 3 and FIG. 4, the saddle assembly 100 also includes a vehicle interface adapter 110 and a releasable adapter engagement mechanism 130 operable to secure the vehicle interface adapter 110 in a stowed configuration and a deployed configuration. The vehicle interface adapter 110 may be one integral piece, such as machined from a single piece of material or the vehicle interface adapter 110 may be include multiple pieces. The vehicle interface adapter 110 may include for example, a channel 111 operable to engage a pinch seam lift point of a vehicle (not shown). The vehicle interface adapter 110 also includes a top surface 14. It is noted however, that the present disclosure contemplates other variations of a vehicle interface adapter as will be discussed in further detail below. The releasable adapter engagement mechanism 130 includes a pivot rod 170 and a spring 173. The saddle assembly 100 further includes an adapter cavity 120 sized to accommodate the vehicle interface adapter 110. Accordingly, in the stowed configuration, the vehicle interface adapter 110 is positioned within the adapter cavity 120 such that the top surface 14 of the vehicle interface adapter 110 is substantially co-planar with the saddle face 105. For example, as shown in FIG. 4, the top surface 14 of the vehicle interface adapter 110 is substantially co-planar with saddle face 105 in the stowed configuration. Similarly, a rod head 171 of pivot rod 170 is also substantially co-planar with the saddle face 105 in the stowed configuration. The rod head 171 of pivot rod 170 may also be below the saddle face 105 in the stowed configuration. In alternative embodiments, the vehicle interface adapter 110 may also be coupled to the saddle body 101 with bolt(s) or another type of fastener capable of coupling the vehicle interface adapter 110 to the saddle body 101. Rather than be stored within the adapter cavity 120, the vehicle interface adapter 110 may be stowed in another location on the vehicle jack 1, e.g., the body 2, the lifting arm 3, etc. More specifically, the vehicle jack 1 may include a fastener, such as a clip, to secure the vehicle interface adapter 110 when not in use to a portion of the vehicle jack 1, such as the body 2 or the lifting arm 3. Additionally, the vehicle jack 1 may include a receptacle to receive the vehicle interface adapter 110 when not in use on a portion of the vehicle jack 1, such as the body 2 or the lifting arm 3.

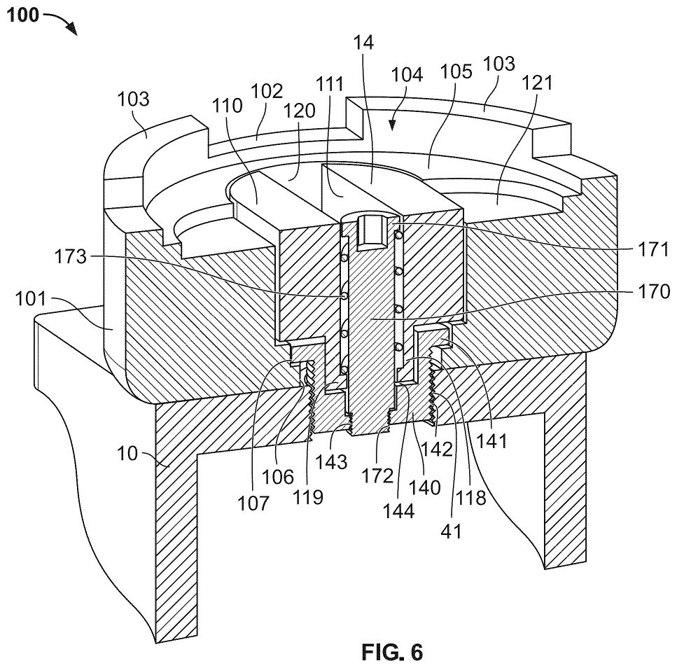

Also disposed on the saddle face 105 is one or more alignment recess(es) 121. The alignment recess 121 is angularly offset from the adapter cavity 120 by approximately 90 degrees (it is understood that other angular arrangements are possible). The alignment recess 121 corresponds to an alignment protrusion 115 of the vehicle interface adapter 110. In the illustrated embodiment, the alignment protrusion 115 is the entirety of the vehicle interface adapter 110. It is contemplated however, as will be discussed below, that other shapes, including additional protrusions are possible. The alignment recess 121 engages with the alignment protrusion 115 of the vehicle interface adapter 110 to align the vehicle interface adapter 110 into the deployed configuration, see FIG. 6.

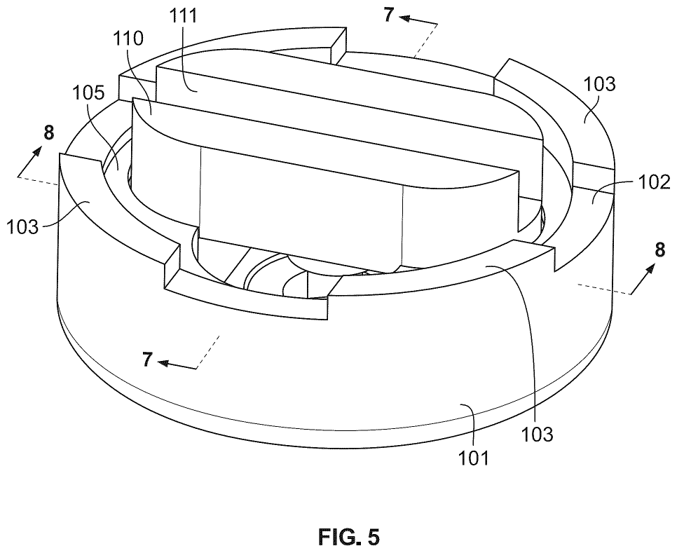

FIG. 4 illustrates the vehicle interface adapter 110 of the saddle assembly 100 in a stowed configuration. FIG. 5 illustrates the vehicle interface adapter 110 in the deployed configuration.

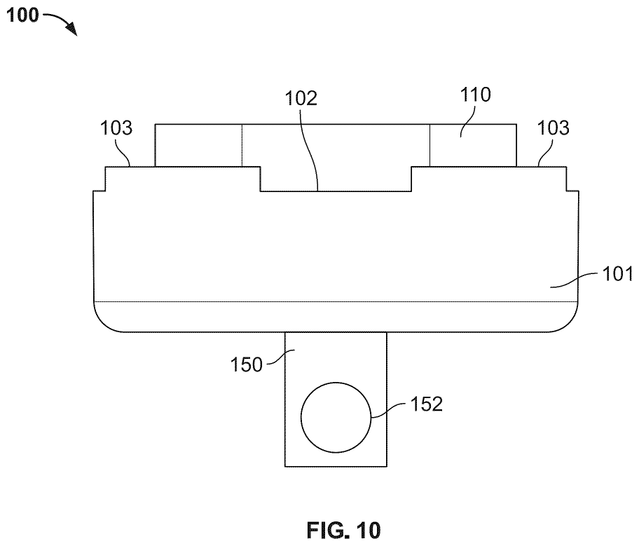

FIG. 6, shows a cross-sectional view of the vehicle interface adapter 110 in the stowed configuration. In such a configuration, the vehicle interface adapter 110 is positioned within the adapter cavity 120 such that the top surface 14 of the vehicle interface adapter 110 is co-planar with the saddle face 105. A saddle bore 106 is formed centrally about the z-axis of the saddle body 101, which aligns with a threaded bore 143 in the mounting bracket 10. The saddle bore 106 is sized to accommodate the saddle fastener 140 or a cross pin fastener 150 (shown in FIG. 10). The illustrated saddle fastener 140 includes a head 141 and threaded portion 142. As illustrated, the vehicle interface adapter 110 further includes a boss 118 extending into a cavity 144 formed within the saddle fastener 140. The spring 173 is positioned between the rod head 171 of the pivot rod 170 and a stopper 119 of the boss 118. The pivot rod 170 is fastened to the saddle fastener 140 via threaded portion 172 which engages with a corresponding threaded bore 143 of the saddle fastener 140. When assembled, the vehicle interface adapter 110 can move vertically along the z-axis and rotate about the pivot rod 170. While in the stowed configuration as shown in FIGS. 4 and 6, the top surface 14 of the vehicle interface adapter 110, saddle face 105, circumferential saddle ridges 102, and/or landings 103 are operable to withstand the load of the vehicle. Optionally, a rubber pad (not shown) could be placed within the recess 104.

The vertical movement of the vehicle interface adapter 110 is limited as when the spring 173 is fully compressed between the rod head 171 of the pivot rod 170 and the stopper 119. It is noted that the length of the pivot rod 170 and depth of the boss 118 are determined by the vertical distance required for the vehicle interface adapter 110 to not interfere with the saddle face 105 when fully extended. Moreover, it is noted that length of the pivot rod 170 is limited by the vertical distance between the threaded bore 143 and saddle face 105 to ensure that the rod head 171 of the pivot rod 170 is co-planar with the saddle face 105 when assembled.

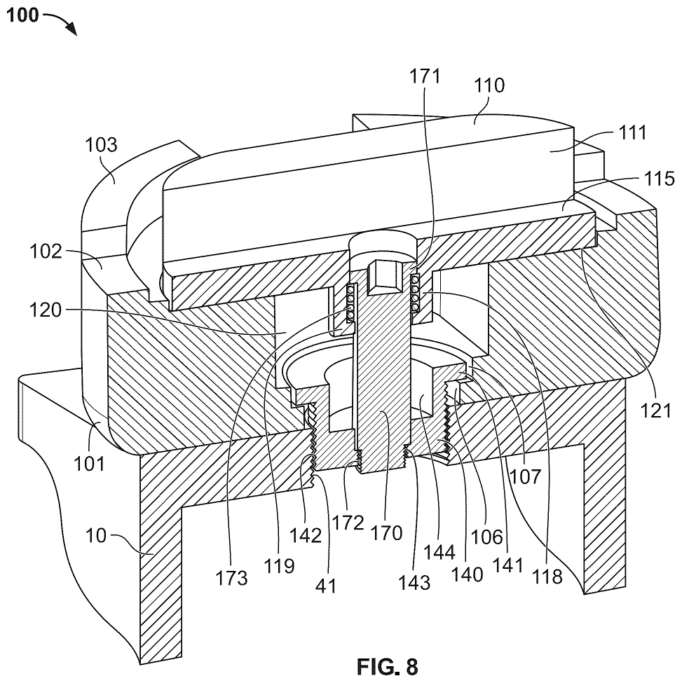

FIG. 8 shows the vehicle interface adapter 110 nested within the alignment recess 121. As illustrated, the entirety of the vehicle interface adapter 110 is the alignment protrusion 115, which corresponds to the shape of the alignment recess 121. While in the deployed configuration as shown in FIGS. 5 and 8, because at least a portion of the vehicle interface adapter 110 is elevated above the saddle face 105, circumferential saddle ridge 102, and/or landings 103, the load of a vehicle would be primarily positioned on the vehicle interface adapter 110.

FIGS. 6-8 further illustrate how the saddle assembly 100 is rotatably mounted (i.e., capable of rotation while fastened to the mounting bracket 10) to the mounting bracket 10 via the saddle fastener 140. A saddle bore 106 includes a saddle fastener recess 107 operable to engage with a head 141 or a head of the saddle fastener 140 or a head of cross pin fastener 150. Threaded shaft 142 engages with a corresponding threaded bore 41 of the mounting bracket 10. The clearance between the head 141 of the saddle fastener, saddle bore 106 and saddle recess 107, allows the saddle assembly 100 to rotate about the z-axis when mounted to the mounting bracket 10 even when the saddle fastener 140 is fastened to threaded bore 41 of mounting bracket 10. It is noted that even in the deployed configuration as illustrated in FIG. 8, the saddle assembly can rotate about the x-axis as described in the preceding paragraph.

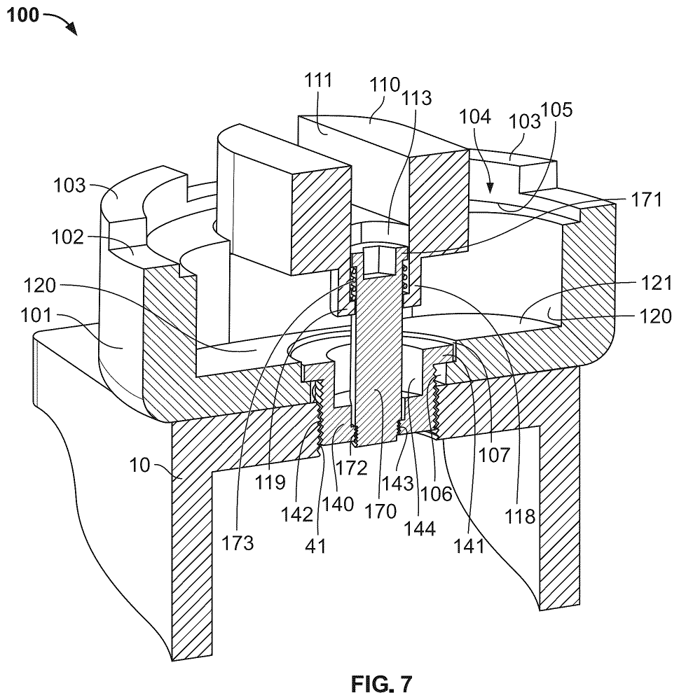

FIGS. 6-8 also illustrate how the spring 173 biases the vehicle interface adapter 110 toward the adapter cavity 120 and the alignment recess 121. For example, FIG. 6 depicts the spring 173 in its natural or uncompressed stated (or close to its uncompressed state). To deploy the vehicle interface adapter 110 from the stowed configuration (FIG. 6) to the deployed configuration (FIG. 8), a user grips the vehicle interface adapter 110, such as by placing a thumb on the outer edge of the vehicle interface adapter 110 and fingers into the channel 111. With a sufficient force to compress the spring 173, the user then pulls the vehicle interface adapter 110 out of the adapter cavity 120 and rotates the adapter 110 clockwise or counterclockwise to align the alignment protrusion 115 with the alignment recess 121 such that the adapter 110 can be seated in the alignment recess 121, as shown in FIGS. 7 and 8. To stow the vehicle interface adapter 110 from the deployed configuration (FIGS. 7 and 8) to the stowed configuration (FIG. 6), a user grips the vehicle interface adapter 110, such as by placing a thumb and fingers on the outer edges of the vehicle interface adapter 110. With a sufficient force to further compress the spring 173, the user then pulls the vehicle interface adapter 110 out of the alignment recess 121 and rotates the adapter 110 clockwise or counterclockwise to align the alignment protrusion 115 with the adapter cavity 120 such that the adapter 110 can be seated in the adapter cavity 120. Consequently, as the vehicle interface adapter 110 is moved upward along the z-axis, the spring 173 becomes compressed between the rod head 171 of the pivot rod 170 and stopper 119 of the boss 118. In FIGS. 7 and 8, the spring 173 is in a compressed state (or close to fully compressed state). Per Hooke's law, the force produced by a spring is proportional to the displacement (in this case compression) of the spring:

$$F = - kx$$

where F is the force, k is the spring constant of the spring, and x is the linear displacement of the spring. Thus, the greater the compression (x), the greater the return force (F). When the spring 173 is fully compressed, it exerts the most force (i.e., biases) onto the vehicle interface adapter 110 towards the adapter cavity 120 and/or alignment recess 121. As the vehicle interface adapter 110 transitions to the stowed configuration or when the vehicle interface adapter 110 is seated in the adapter cavity 120, the spring 173 exerts a sufficient force to bias the vehicle interface adapter 110 into the alignment recess 121, ensuring that the vehicle interface adapter 110 is positively seated. Likewise, as the vehicle interface adapter 110 transitions to the deployed configuration or when the vehicle interface adapter 110 is seated in the adapter cavity 120, the force of the spring 173 biases the vehicle interface adapter 110 into the adapter cavity 120 to ensure it is positively seated and that the exposed portion of the vehicle interface adapter 110, e.g., the top surface 14, is co-planar with the saddle face 105.

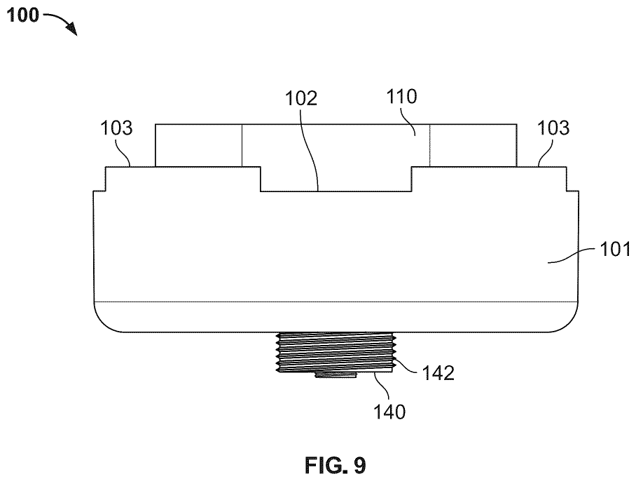

FIGS. 9 and 10 show side elevation views of the saddle assembly 100 with two types of saddle fasteners. Specifically, FIG. 9 depicts the threaded saddle fastener 140 as described above. FIG. 10 depicts the cross pin fastener 150. The cross pin fastener 150 includes a head (not shown) that functions similarly to the head 141 of the threaded fastener 140 as described above. Likewise, the cross pin fastener 150 may include a threaded bore (not shown) similar to the threaded bore 143 of the threaded fastener 140 as described above. Finally, the cross pin fastener 150 includes a cross pin bore 152 operable to receive a pin (not shown) to mount and secure the saddle assembly 100 to the mounting bracket 10 (not shown). In such an embodiment the mounting bracket 10 includes a corresponding pin bore that aligns with the pin bore 152 of the cross pin fastener 150 to receive a pin (not shown).

FIG. 11 shows an exploded view of another embodiment of a saddle assembly 100 for the vehicle jack 1. As shown, the saddle assembly 100 includes a saddle body 101. The saddle body 101 is made of metal (e.g., steel, or high strength plastic, or aluminum) or any other suitable material for withstanding the load of the vehicle during operation. The saddle body 101 is mounted to the mounting bracket 10. Specifically, the saddle body 101 is mounted to the mounting bracket 10 using either the threaded saddle fastener 140 or a cross pin fastener 150 (shown for example in FIG. 10).

Referring to FIG. 11, the saddle body 101 has a perimeter 12 including a plurality of circumferential saddle ridges 102 and a plurality of landings 103. The perimeter 12 defines a recess 104 and surrounds the saddle face 105. Two notches 108 are formed into the circumferential saddle ridge 102 to a depth of the alignment recess 121. A saddle bore 106 is formed centrally about the z-axis of saddle body 101, which aligns with a threaded bore (not shown) in the mounting bracket 10. The saddle bore 106 is sized to accommodate a saddle fastener 140 (not shown) or a cross pin fastener 150 (not shown).

As shown in FIG. 11, the saddle assembly 100 also includes a vehicle interface adapter 110 and a releasable adapter engagement mechanism 130 operable to secure the vehicle interface adapter 110 in the stowed configuration and the deployed configuration. As illustrated, the releasable adapter engagement mechanism 130 consists of a flange 114 and a plurality of end adapter bore fasteners 160 that engage with corresponding end adapter bores 116. As illustrated the vehicle interface adapter 110 includes a flange interface 15 for positioning the flange 114 on the vehicle interface adapter 110. The flange interface 15 includes an indented portion 16 and at least two raised portions 17. The raised portions 17 are located on opposing sides of the vehicle interface adapter 110 and are generally semi-circular in shape. The indented portion 16 is generally square in shape and located between the raised portions 17. The raised portions 17 and the indented portion 16 may be other shapes in alternative embodiments. The flange 114 is fastened to the vehicle interface adapter 110 via a plurality of middle adapter bore fasteners 161, which extend through the middle adapter bores 116a located on the flange 114 and into the threaded bores 40 located on the indented portion 16 of the vehicle interface adapter 110. As illustrated, the middle adapter bore fasteners 161 are at least partially positionable within countersink 117 such that the tapered head of the middle adapter bore fastener 161 is co-planar with the flange 114. It is understood that while the vehicle interface adapter 110 and flange 114 are illustrated as separate pieces, that the vehicle interface adapter 110 and flange 114 could also be a single integral piece (i.e., machined from a single piece of material).

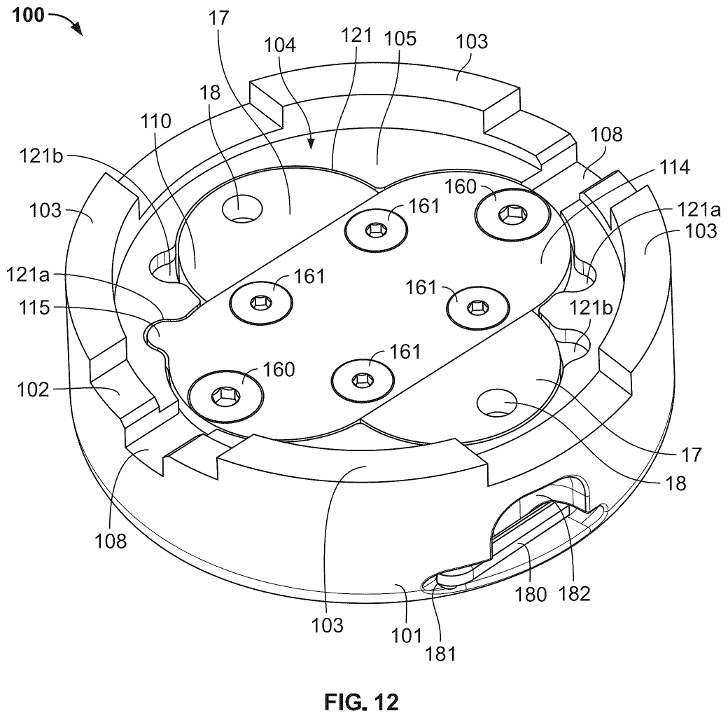

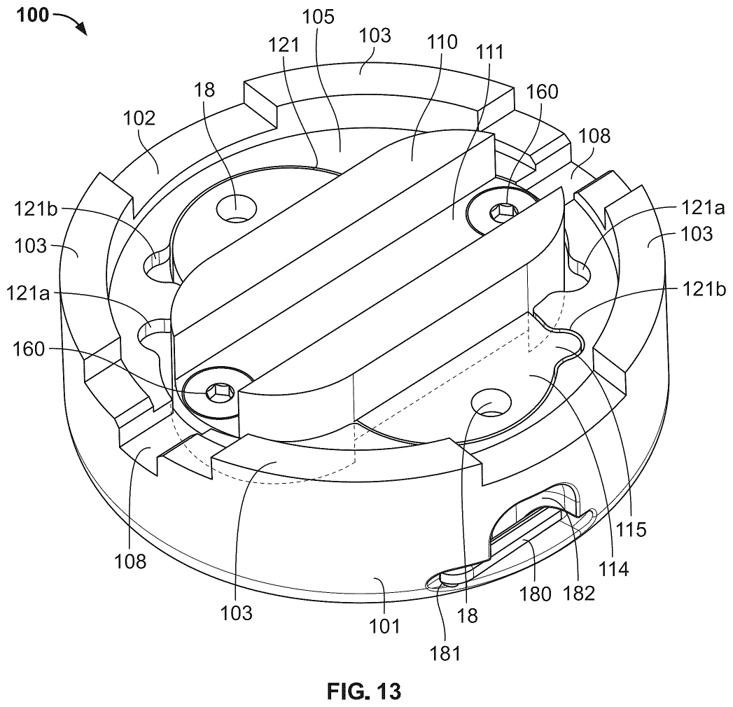

The vehicle interface adapter 110 also includes a through-hole 18 adapted to receive end adapter bore fasteners 160. In the stowed configuration, the end adapter bore fasteners 160 are configured to extend through the end adapter bores 116 of the vehicle interface adapter 110 and into a saddle body bore 19 located on an alignment recess 121, see FIG. 12. In the deployed configuration, the end adapter bore fasteners 160 are configured to extend through the through-hole 18 of the vehicle interface adapter 110 and into the saddle body bore 19 located on the alignment recess 121, see FIG. 13.

As illustrated in FIG. 11, the heads of the end adapter bore fasteners 160 are positioned within countersinks 117 such that the heads are co-planar with the vehicle interface adapter 110. In some embodiments, different size or shape fasteners 160 may be used. In these embodiments, bores 116, 19 and 18, and countersinks 117, are also the same size and shape to correspond with fasteners 160. The present disclosure contemplates that the heads of the end adapter bore fasteners 160 are comprised of a variety of shapes such as a countersunk (tapered) head. The present disclosure also contemplates that the end adapter bore fasteners 160 are comprised of a variety of diameters and lengths, including, a variety of shank lengths, thread lengths, and thread pitches. It is also understood that the vehicle interface adapter may be comprised of more than one piece, such as a flange coupled to a vehicle interface adapter base.

Referring to FIG. 11, the saddle assembly 100 further includes a tool 180 operable to engage any of the end adapter bore fasteners 160 or the middle adapter bore fasteners 161. As illustrated, the tool 180 is an Allen wrench and the end adapter bore fasteners 160 and the middle adaptor bore fasteners 161 are flat head countersunk bolts including an Allen socket drive. It is understood that the present disclosure contemplates other tools/bolts and that the disclosure should not be limited to the illustrated embodiment. The saddle body 101 also includes a tool storage recess 181 operable to stow the tool 180 within the saddle body 101. Finally, the saddle body 101 includes a finger cutout 182 enabling an operator to grasp and pull the tool 180 when the tool 180 is stored within tool storage recess 181.

FIGS. 11-13 also illustrate, disposed on the saddle face 105, the plurality alignment recesses 121. The alignment recess 121 is angularly offset from an adapter cavity 120 by approximately 90 degrees (it is understood that other angular arrangements are possible). The main alignment recess 121 corresponds to the flange 114. The alignment protrusion 115 is operable to engage with a plurality of stowed configuration alignment recesses 121a and deployed configuration alignment recesses 121b. The positioning of the alignment protrusion 115 relative to the at least one stowed configuration alignment recess 121a is asymmetrical. Thus, when the alignment protrusion 115 engages with either of the stowed configuration alignment recesses 121a, the vehicle interface adapter 110 is properly positioned in the stowed configuration. Likewise, a positioning of the alignment protrusion 115 relative to the at least one deployed configuration alignment recesses 121b is asymmetrical. Thus, when the alignment protrusion 115 engages with either of the deployed configuration alignment recesses 121b, the vehicle interface adapter 110 is properly positioned in the deployed configuration. In alternative embodiments, different types of alignment features may be incorporated such as asymmetric shapes to prevent misalignment between the vehicle interface adapter and the saddle face.

FIG. 12 shows the saddle assembly 100 with the vehicle interface adapter 110 in a stowed configuration. As illustrated, the alignment protrusion 115 is positioned within one of the stowed configuration alignment recesses 121a. It is noted, that the vehicle interface adapter 110 may be rotated by 180 degrees around the z-axis such that the alignment protrusion 115 engages with the opposite stowed configuration alignment recess 121a. In the stowed configuration, any exposed portion of the vehicle interface adapter 110, flange 114, saddle face 105, circumferential saddle ridge 102, and/or landing 103 are operable to withstand the load of a vehicle. Optionally, a rubber pad (not shown) could be placed within a recess 104. The outer end adapter bore fasteners 160 secure the vehicle interface adapter 110 to the saddle body 101 via corresponding threaded portions of the saddle body bores 19 located on the alignment recess 121.

FIG. 13 shows the vehicle interface adapter 110 in a deployed configuration. As illustrated, the alignment protrusion 115 of the flange 114 is positioned within one of the deployed configuration alignment recesses 121b. It is again noted, that the vehicle interface adapter 110 maybe rotated by 180 degrees around the z-axis such that the alignment protrusion 115 engages with the opposite deployed configuration alignment recess 121b. While in the deployed configuration, because the vehicle interface adapter 110 is elevated above the saddle face 105, circumferential saddle ridge 102, and/or landings 103, the load of a vehicle would be primarily positioned on the vehicle interface adapter 110.

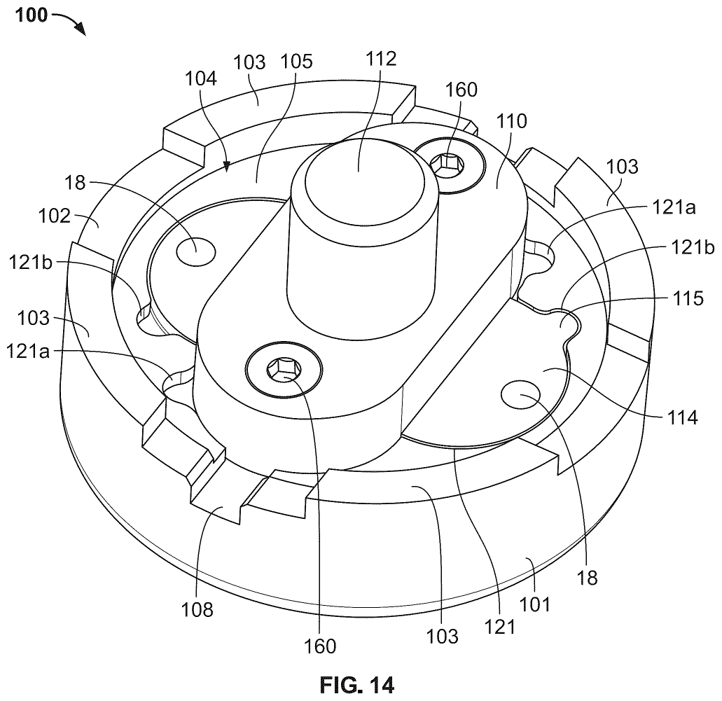

As illustrated in FIG. 13, the vehicle interface adapter 110 includes a channel 111 operable to engage with a pinch seem or similar component on the vehicle frame (not shown). The notches 108 are in-line with the channel 111 to enable the saddle assembly 100 to be used with a wider range of lift points including for example a stepped pinch seam. The present disclosure also contemplates other shapes of adapters. For example as shown in FIG. 14, the vehicle interface adapter 110 could include a pin 112 operable to engage with a corresponding recess (e.g., reinforced hole) on the vehicle frame. The present disclosure contemplates all shapes of adapters including without limitation, square, rectangular, oval, triangular, etc. or any combination thereof.

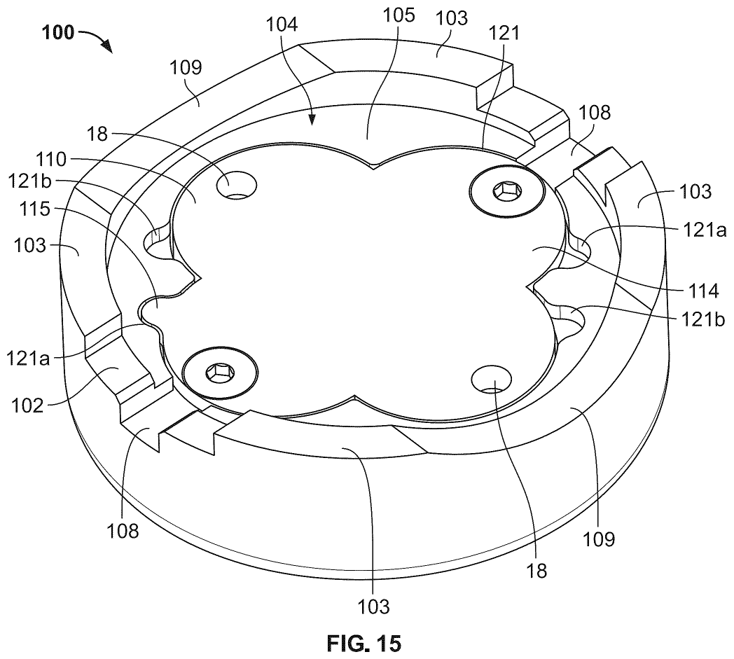

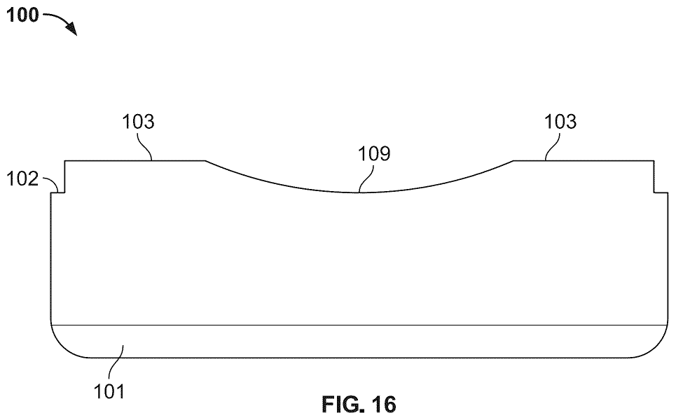

FIGS. 15-16 illustrate an alternative embodiment of a saddle assembly 100 of FIG. 11, including a rounded cutout 109 between two adjacent landings 103. In additional to the advantages discussed above, such rounded cutouts 109 are a suitable lifting contact for axles of corresponding shapes, such as rounded axle tubes, thereby providing increased adaptability of the saddle assembly 100.

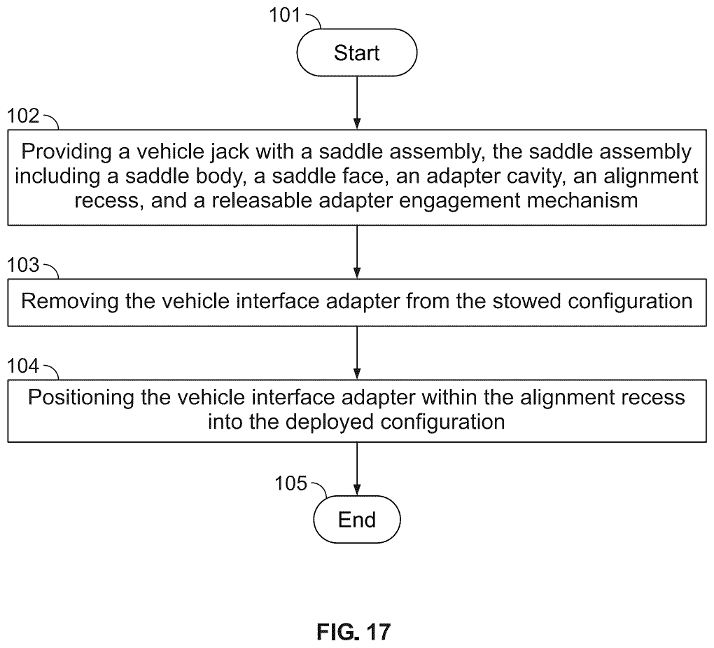

The present disclosure also contemplates a method of configuring the vehicle interface adapter 110 for the vehicle jack 1 from the stowed configuration into the deployed configuration. Referring to FIG. 17, the example method steps may start at step 101 and end at step 105. At step 102, the method comprises providing the vehicle jack 1 with the saddle assembly 100, the saddle assembly including the saddle body 101, the saddle face 105, the adapter cavity 120, the alignment recess 121, and the releasable adapter engagement mechanism 130. At step 103, the vehicle interface adapter 110 removed from the stowed configuration. At step 104, the vehicle interface adapter is positioned within the alignment recess into the deployed configuration.

In an alternative embodiment the releasable adapter engagement mechanism 130 includes at least one end adaptor bore fastener 160 and at least one corresponding saddle body bore 19 that is threaded and disposed within the alignment recess 121, and the vehicle interface adapter 110 includes at least one through-hole 18. In such an embodiment the method further comprises releasing the vehicle interface adapter 110 from the stowed configuration by dis-engaging and removing the least one end adaptor bore fastener 160 from the at least one corresponding saddle body bore 19; and securing the vehicle interface adapter 110 into the deployed configuration by rotating the vehicle interface adapter 110 such that the channel 111 is exposed to permit interaction with the vehicle; and then inserting at least one end adaptor bore fastener 160 through the through-hole 18 and re-engaging the end adaptor bore fastener 160 with the corresponding saddle body bore 19.

In another alternative embodiment, the releasable adapter engagement mechanism 130 includes a pivot rod 170, disposed in the adapter cavity 120 and positioned at least partially within a pivot bore 113 of the vehicle interface adapter 110, and a spring 173 positioned around the pivot rod 170, which biases the vehicle interface adapter 110 toward the adapter cavity 120 or alignment recess 121, such that when the vehicle interface adapter 110 is aligned with either of the adapter cavity 120 or the alignment recess 121, it is positively seated. In such an embodiment the method further comprises raising the vehicle interface adapter 110 above the saddle face 105 and rotating the vehicle interface adapter 110 about the pivoting rod 170.

The present described disclosure is described in such full, clear, concise, and exact terms as to enable any person skilled in the art to which it pertains to practice the same. It is to be understood that the foregoing described preferred aspects of the disclosure and that modification may be made therein without departing from the spirit of scope of the disclosure as set forth in the appended claims. The scope of the following claims is to be accorded the broadest interpretation to encompass all such modifications and equivalent structures and functions. Therefore, it is intended that the application not be limited to the particular aspects disclosed, but that the application will include all aspects falling within the scope of the appended claims.

What is claimed:

1. A saddle assembly for a vehicle jack comprising:
a saddle body, the saddle body including a saddle face;
a vehicle interface adapter; and
a releasable adapter engagement mechanism,
wherein the releasable adapter engagement mechanism is operable to secure the vehicle interface adapter in a stowed configuration and a deployed configuration.

2. The saddle assembly of claim 1, wherein the saddle body further comprises an adapter cavity and the stowed configuration comprises substantially positioning the vehicle interface adapter within the adapter cavity.

3. The saddle assembly of claim 2, wherein when the vehicle interface adapter is in the stowed configuration, the vehicle interface adapter is substantially co-planar with the saddle face.

4. The saddle assembly of claim 1, wherein the deployed configuration comprises positioning the vehicle interface adapter on the saddle face, such that the vehicle interface adapter is operable to engage a lift point of a vehicle.

5. The saddle assembly of claim 4, wherein the vehicle interface adapter comprises a channel operable to engage the lift point of the vehicle, wherein the lift point of the vehicle is a pinch seam.

6. The saddle assembly of claim 5, wherein the saddle body further comprises:
a circumferential saddle ridge; and
a plurality of notches disposed on the circumferential saddle ridge,
wherein at least one of the plurality of notches corresponds with the channel when the vehicle interface adapter is in the deployed configuration.

7. The saddle assembly of claim 4, wherein the vehicle interface adapter comprises a pin operable to engage a corresponding recess on the vehicle.

8. The saddle assembly of claim 1, wherein the releasable adapter engagement mechanism comprises at least one fastener and at least one corresponding bore disposed on the saddle face, and the vehicle interface adapter includes at least one adapter bore, wherein the at least one fastener is operable to engage with at least one interface bore and the at least one corresponding bore to secure the vehicle interface adapter to the saddle body in the stowed configuration and the deployed configuration.

9. The saddle assembly of claim 8, wherein the releasable adapter engagement mechanism further comprises a tool operable to engage the at least one fastener.

10. The saddle assembly of claim 9, wherein the saddle body further comprises a tool storage recess operable to stow the tool within the saddle body.

11. The saddle assembly of claim 8, wherein:
the vehicle interface adapter includes at least one alignment protrusion; and
the saddle face includes at least one stowed configuration alignment recess and at least one deployed configuration alignment recess,
wherein a positioning of the at least one alignment protrusion relative to the at least one stowed configuration alignment recess is asymmetrical, thereby ensuring that the vehicle interface adapter is properly positioned in the stowed configuration; and
a positioning of the at least one alignment protrusion relative to the at least one deployed configuration alignment recess is asymmetrical, thereby ensuring that the vehicle interface adapter is properly positioned in the deployed configuration.

12. The saddle assembly of claim 3, wherein the releasable adapter engagement mechanism comprises:
a pivot rod disposed in the adapter cavity and positioned at least partially within a pivot bore of the vehicle interface adapter;
a spring positioned around the pivot rod; and
an alignment recess disposed on the saddle face, wherein:
the alignment recess is angularly offset from the adapter cavity and defines a shape that substantially conforms to the vehicle interface adapter;
the vehicle interface adapter is operable to pivot about the pivot rod into the deployed configuration;
the vehicle interface adapter is substantially positioned within the alignment recess when in the deployed configuration; and
the spring biases the vehicle interface adapter toward the adapter cavity, such that when the vehicle interface adapter is aligned with either of the adapter cavity or the alignment recess, it is positively seated.

13. A vehicle jack comprising:
a body;
a lifting arm pivotally connected to the body operable to move between an upper extended position and a lower retracted position;
a mounting bracket pivotally connected to an end of the lifting arm; and
a jack saddle assembly fastened to the mounting bracket; wherein the jack saddle assembly comprises:
a saddle body, the saddle body including a saddle face;
a vehicle interface adapter; and
a releasable adapter engagement mechanism,
wherein the releasable adapter engagement mechanism is operable to secure the vehicle interface adapter in a stowed configuration and a deployed configuration.

14. The vehicle jack of claim 13, wherein the saddle body further comprises an adapter cavity and the stowed configuration comprises substantially positioning the vehicle interface adapter within the adapter cavity.

15. The vehicle jack of claim 14, wherein when the vehicle interface adapter is in the stowed configuration, the vehicle interface adapter is substantially co-planar with the saddle face.

16. The vehicle jack of claim 13, wherein the deployed configuration comprises positioning the vehicle interface adapter on the saddle face, such that the vehicle interface adapter is operable to engage a vehicle.

17. The vehicle jack of claim 16, wherein the vehicle interface adapter comprises a channel operable to engage rib-shaped lift point on the vehicle.

18. The vehicle jack of claim 17, wherein the saddle body further comprises:
a circumferential saddle ridge; and
a plurality of notches disposed on the circumferential saddle ridge,
wherein at least one of the plurality of notches is positioned in-line with the channel when the vehicle interface adapter is in the deployed configuration.

19. The vehicle jack of claim 16, wherein the vehicle interface adapter comprises a pin operable to engage a corresponding recess on the vehicle.

20. The vehicle jack of claim 13, wherein the releasable adapter engagement mechanism comprises at least one threaded fastener and at least one corresponding threaded bore disposed on the saddle face, and the vehicle interface adapter includes at least one adapter bore, wherein the at least one threaded fastener is operable to engage with at least one interface bore and the at least one corresponding threaded bore to secure the vehicle interface adapter to the saddle body in the stowed configuration and the deployed configuration.

21. The vehicle jack of claim 20, wherein the releasable adapter engagement mechanism further comprises a tool operable to engage the at least one threaded fastener, and the at least one threaded fastener comprises a countersunk allen bolt.

22. The vehicle jack of claim 21, wherein the saddle body further comprises a tool storage recess operable to stow the tool within the saddle body.

23. The vehicle jack of claim 20, wherein:
the vehicle interface adapter includes at least one alignment protrusion; and
the saddle face includes at least one stowed configuration alignment recess and at least one deployed configuration alignment recess,
wherein a positioning of the at least one alignment protrusion relative to the at least one stowed configuration alignment recess is unidirectional, thereby ensuring that the vehicle interface adapter is properly positioned in the stowed configuration; and
a positioning of the at least one alignment protrusion relative to the at least one deployed configuration alignment recess is unidirectional, thereby ensuring that the vehicle interface adapter is properly positioned in the deployed configuration.

24. The vehicle jack of claim 15, wherein the releasable adapter engagement mechanism comprises:
a pivot rod disposed in the adapter cavity and positioned at least partially within a pivot bore of the vehicle interface adapter;
a spring positioned around the pivot rod; and
an alignment recess disposed on the saddle face, wherein:
the alignment recess is substantially perpendicular to the adapter cavity and defines a shape that substantially conforms to the vehicle interface adapter;
the vehicle interface adapter is operable to pivot about the pivot rod into the deployed configuration;
the vehicle interface adapter is substantially positioned within the alignment recess when in the deployed configuration; and
the spring biases the vehicle interface adapter toward the adapter cavity, such that when the vehicle interface adapter is aligned with either of the adapter cavity or the alignment recess, it is positively seated.

25. A Method of configuring a vehicle interface adapter for a vehicle jack from a stowed configuration into a deployed configuration:
providing a vehicle jack with a saddle assembly, the saddle assembly including a saddle body, a saddle face, an adapter cavity, an alignment recess, and a releasable adapter engagement mechanism;
removing the vehicle interface adapter from the stowed configuration; and
positioning the vehicle interface adapter within the alignment recess into the deployed configuration.

26. The method of claim 25, wherein the releasable adapter engagement mechanism includes at least one threaded fastener and at least one corresponding threaded bore disposed within the alignment recess, and the vehicle interface adapter includes at least one adapter bore, the method further comprising:
releasing the vehicle interface adapter from the stowed configuration by dis-engaging and removing the least one threaded fastener from the at least one corresponding threaded bore and adapter bore; and
securing the vehicle interface adapter into the deployed configuration by inserting the at least one threaded fastener through the adapter bore and re-engaging the at least one threaded fastener with the at least one corresponding threaded bore.

27. The method of claim 25, wherein the releasable adapter engagement mechanism includes a pivot rod, disposed in the adapter cavity and positioned at least partially within a pivot bore of the vehicle interface adapter, and a spring positioned around the pivot rod, which biases the vehicle interface adapter toward the adapter cavity, such that when the vehicle interface adapter is aligned with either of the adapter cavity or the alignment recess, it is positively seated, the method further comprising;
raising the vehicle interface adapter above the saddle face; and
rotating the vehicle interface adapter about the pivoting rod.
